(19) United States
(12) Patent Application Publication
(10) Pub. No.: US 2021/0087003 A1
(43) Pub. Date: Mar. 25, 2021

(54) METHOD AND DEVICE FOR LOADING AND/OR UNLOADING LAUNDRY MACHINES, IN PARTICULAR WASHING MACHINES, DRYERS OR SIMILAR

(71) Applicant: Herbert Kannegiesser GmbH, Vlotho (DE)

(72) Inventors: Wilhelm Bringewatt, Porta Westfalica (DE); Engelbert Heinz, Vlotho (DE)

(73) Assignee: Herbert Kannegiesser GmbH, Vlotho (DE)

(21) Appl. No.: 17/023,978

(22) Filed: Sep. 17, 2020

(30) Foreign Application Priority Data
Sep. 23, 2019 (DE) 102019006649.9
Dec. 13, 2019 (DE) 102019008672.4
May 22, 2020 (DE) 102020003085.8

(51) Int. Cl. B65G 65/02; D06F 95/00

(52) U.S. Cl. CPC B65G 65/02; D06F 95/00

(57) ABSTRACT

A device and method for providing temporary storage of dirty washing in a store in front of the continuous washing machines to be loaded. The laundry reaches the store by a first non-constant conveyor, is taken from the store by a second non-constant conveyor and transported to the continuous washing machine which is then loaded with this laundry. In commercial laundries, for example, continuous washing machines are loaded with dirty washing from laundry bags. The laundry bags hang from a rail transport system and are partly transported to the continuous washing machines under force of gravity. The laundry bags in the rail transport system establish the order of loading of the continuous washing machine. The rail transport systems are extremely susceptible to fault, in particular in their downward sloping sections for transport under force of gravity, and require a great deal of space in the laundry.

### CROSS REFERENCE TO RELATED APPLICATIONS

This patent application claims priority on and the benefit of German Patent Application No. 10 2019 006 649.9 having a filing date of 23 Sep. 2019, German Patent Application No. 10 2019 008 672.4 having a filing date of 13 Dec. 2019, and German Patent Application No. 10 2020 003 085.8 having a filing date of 22 May 2020.

### BACKGROUND OF THE INVENTION

### Technical Field

The invention concerns a method for loading and/or unloading laundry machines, in particular washing machines, dryers or similar, wherein the laundry is transported to the laundry machine to be loaded, and the laundry is loaded into the laundry machine and/or unloaded from the laundry machine and transported away. The invention furthermore concerns a device for loading and/or unloading laundry machines, in particular washing machines, dryers or similar, with at least one conveyor for loading the laundry machine and/or for unloading the laundry machine.

### Prior Art

Laundry machines, in particular washing machines and dryers, are loaded with laundry and/or unloaded in batches or loads. Each washing batch or washing load contains a plurality of laundry items which can be treated similarly.

It is known that washing, namely dirty washing, delivered to a laundry, is transported to the washing machine to be loaded in laundry bags after sorting. Usually, a laundry bag contains a quantity of washing forming a laundry batch or load. The laundry bags, hanging from rails, are transported to the washing machine to be loaded along a conveyor line formed by the rails. The conveyor line may be configured as a downwardly sloping conveyor line in portions.

With this known method of supplying laundry machines, the order of treatment of the washing is predefined by the order of the laundry bags containing the washing along the conveyor line. Selective treatment of the laundry in the laundry bags, for example the successive treatment of identical or similar laundry in laundry bags at different points on the conveyor line, is not therefore possible. Also, it has been found that the onward transport of the laundry bags along the rails of the conveyor line is susceptible to fault, in particular in regions of gravity-powered transport without drive. Further disadvantages arise in the unloading and/or discharge of the washed and preferably dried laundry. Previously this has taken place using laundry transport containers or belt conveyors.

### BRIEF SUMMARY OF THE INVENTION

The invention is based on the object of providing a method and a device for loading laundry machines with washing in batches or loads, and/or discharging the treated laundry in batches or loads, which allows a reliable, in particular robust and largely arbitrary supply of laundry machines with different types of washing to be treated, and/or a reliable and simple discharge of the treated laundry.

A method for achieving this object comprises a method for loading and/or unloading laundry machines with laundry, wherein the laundry is transported to the laundry machine to be loaded, and the laundry is loaded into the laundry machine and/or unloaded from the laundry machine and transported away, wherein the laundry is transported to at least one store and temporarily stored there, wherein the laundry is transported from the store to the laundry machine and the laundry machine is loaded with the laundry, and/or the laundry unloaded from a laundry machine is transported to another store and temporarily stored there. In the method, it is provided that the laundry is transported to at least one store which allows temporary storage of the laundry. It is also provided that the laundry to be washed is transported in targeted fashion from the store to the laundry machine, which is then loaded with the desired laundry, and/or the laundry unloaded from the laundry machine used for washing, or from a downstream laundry machine, is transported in targeted fashion to another store. The targeted discharge and/or delivery of the laundry from and/or to the respective store allows flexible loading and/or unloading of the laundry machine. The laundry machine can then be loaded in targeted fashion with laundry from the store arranged in front of it. In addition, the at least one store shortens the conveyor lines and thus makes them less susceptible to fault.

Preferably, it is provided that the laundry is transported to the store in a container, the laundry is transferred from the container to the store, and the laundry is transferred from the store to a loading container which transports the laundry to the laundry machine. The laundry machine is loaded by unloading the loading container at said laundry machine. The last laundry machine involved in treating the laundry is unloaded in reverse fashion. The treated laundry is transferred to an unloading container which transports the laundry batch contained therein to the store. From the store, the laundry is transferred as required to a container which transports the laundry further, for example to a mangle, folding machine or similar.

Preferably, the loading capacity of the loading container or unloading container is selected such that it can receive a quantity of washing which corresponds to a laundry batch or load, and is thereby adapted to the loading capacity of the laundry machine. It is however also conceivable to form a laundry batch or load from laundry in several loading containers, and to load the laundry machine in stages with multiple parts of the laundry batch. Also, in some cases, the unloading container may have a smaller holding capacity than the loading container.

Preferably, it is provided that the still untreated, preferably unwashed laundry is transferred from the respective container into a loading container in the region of the store. The quantity of laundry in the container may differ from the quantity of laundry in the loading container. For example, the quantity of laundry in the container may be smaller than the quantity of laundry required to form a laundry batch or load. The procedure is reversed for unloading the treated, preferably washed and dried laundry. On unloading, this laundry is transferred to the unloading container in batches or part batches, and the treated laundry is then transferred to the store for temporary storage. From the store, the treated laundry is then loaded in targeted fashion, namely according to requirements, in batches or loads into a container which supplies the laundry for further use.

An advantageous possible embodiment of the method provides that the container loaded with laundry is transported by means of a non-constant conveyor to the store, and from the store the laundry is transported by the loading container via preferably another non-constant conveyor to the laundry machine to be loaded. On unloading of the treated laundry from said laundry machine or another downstream laundry treatment machine, the treated laundry is loaded in batches into the unloading container which is then transported by another, first non-constant conveyor to another store. From this store, a desired laundry batch is loaded into an assigned container which is transported away by another, second non-constant conveyor.

In this way, the loading and unloading of the store can take place independently. In particular, the order of loading the store with laundry may differ from the order of unloading the laundry from the store. Thus, a targeted extraction of laundry, in particular laundry of a specific type, from the store is possible. This results in a flexible unloading of the respective laundry machine.

The method may be refined in that laundry from the container and/or unloading container can be discharged into any of a plurality of storage sites for laundry in the respective store. It is thus possible to deposit laundry from the container or unloading container into any free storage site of the respective store. The storage sites of the store may thus be filled arbitrarily with laundry. It is however also conceivable that a storage site or sites which does/do not yet contain a sufficient quantity of laundry for a complete laundry batch, can be “topped up” in that laundry of a similar type can be discharged from another container or unloading container into the same storage site which is already partly filled with laundry.

Furthermore, the method may be configured such that, because of the arbitrary filling of storage sites without an ordering system, the conveyors, in particular non-constant conveyors, are assigned electronic navigation devices which preferably supply data, in particular positional data, on each filling and/or emptying of a respective storage site. These data are stored electronically so that a second conveyor may have access to these data, preferably positional data. Using these data, a controller of for example the second conveyor, in particular a non-constant conveyor, may control this for targeted extraction of laundry from a specific storage site. In particular, it is thus possible to extract laundry of the same type from different storage sites in succession.

It is also conceivable to assign a weighing device to at least one container, the loading container and/or unloading container. Thus, the weight of laundry in at least one container, unloading container and/or loading container can be determined. The weight of the laundry discharged at a specific storage site can then also be stored, preferably in addition to the data (in particular coordinates) on the position of the respective storage site. In this way, the loading state of each storage site in the respective store is known. Preferably, it is also known which laundry, preferably which type of laundry, is located in each storage site, and which storage site is empty. It is thus also possible to top up a storage site which is not yet sufficiently filled for a laundry batch.

A device for achieving the object cited initially is a device for loading and unloading laundry machines, with at least one conveyor for loading the laundry machine and/or for unloading the laundry machine, wherein at least one store with a plurality of storage sites is arranged in front of and/or behind the laundry machine to be loaded, wherein the laundry with a container and/or unloading container containing this can be moved by at least one first non-constant conveyor to the respective store, and at least one second non-constant conveyor is provided with a loading container and/or a container which moves the laundry from a storage site of the respective store to the laundry machine to be loaded with the laundry, and/or transports treated laundry away. This device has one or a respective store with a plurality of storage sites in front of and/or behind the laundry machine to be loaded or another laundry machine. The container or unloading container containing the laundry can be moved by a conveyor to the store. A further conveyor with a container or a loading container for laundry from the or the respective store is provided, in order to move the laundry in the loading container to the laundry machine and/or transport it away from the store in a container. The at least one store with several storage sites replaces a long conveyor line, leading to a compact, space-saving device. Because one conveyor is provided for supplying the storage sites and another conveyor for loading and/or unloading, supplying and unloading of the store may take place independently. The device according to the invention thereby allows flexible loading of laundry machines independently, without being susceptible to fault.

Preferably, it is provided that the at least one store has a plurality of similar and/or coherent storage sites. Because of the plurality of storage sites, the or each store can contain a sufficient quantity of laundry to be treated. The similar and/or coherent storage sites make the device very compact, so it requires less space than the formerly common rail-mounted conveyor systems with long conveyor lines.

According to a preferred possible embodiment of the at least one store, the storage sites are arranged next to each other and/or behind each other in a grid pattern, in particular in rows and columns. This means that the walls of adjacent stores adjoin each other directly and common walls may be provided between adjacent storage sites. In this way, at the same time storage sites are connected together.

Storage sites of square or hexagonal cross-section are particularly advantageous because in this way there are no gaps or spaces between any adjacent storage sites. Thus, the entire bottom surface area of the respective store is available for the storage sites.

Preferably, the cross-sections or bottom faces of the at least one container, the loading container and/or the unloading container, correspond to the bottom face or cross-section of each of the identically formed storage sites. As a result, the conveyors, in particular non-constant conveyors, can position the container and/or unloading container over the respective storage site, or position the loading container or container below the respective storage site so as to be congruent above or below the respective storage site; or in other words, the faces or cross-sections of the at least one container and loading container or unloading container can be brought to cover the cross-section or face of each storage site. In this way, the laundry can be loaded into the respective storage site reliably and completely, and conversely the laundry contained in the respective storage site can be completely loaded therefrom into another container or loading container. Faults and incorrect loading are thereby excluded.

Preferably, each of the in particular identically formed storage sites of the at least one store is provided with a floor which can be opened for unloading the respective storage site. The floor need not necessarily be part of the store. The opening process of the floor can preferably be started only after the container and/or loading container for the laundry from said storage site has moved to precisely below the respective storage site. The floor remains open only for the duration of transfer of the laundry items from the storage site. After transfer of the laundry, it is closed again. Alternatively, it is also conceivable to empty the storage sites not via opening floors but via sliding lateral openings.

According to a particularly advantageous possible embodiment of the device, the conveyors, in particular the non-constant conveyors, are equipped with controllers and data memories. The controllers have means for determining the position of the storage site at which the respective container and/or unloading container should be emptied. The positional data can be stored in the data memory and be used at least by the conveyor, in particular non-constant conveyor, with the container or loading container in order to move this in targeted fashion to a storage site from which the container or loading container is to be filled with laundry. By detecting the position and storing the positional data, in particular also data on the type of laundry, and by a corresponding control of preferably both conveyors, the respective controller knows which storage site is occupied and which laundry is situated in the respective occupied storage site. Then the second conveyor having the loading container or another container may, for targeted extraction of specific laundry, approach a storage site containing such laundry and transport the laundry extracted from the storage site to a corresponding loading position at the laundry machine in order to load the laundry machine, or extract the treated laundry in targeted fashion from its storage site in the store for treated laundry and transport it away.

At least one and preferably all conveyors of the device are preferably formed as non-constant conveyors. The conveyors may be non-constant conveyors of the same principle and/or same type. It is also preferably provided that the non-constant conveyors are formed as cranes, robots or grippers. For example, the non-constant conveyors may in particular be crane-like non-constant conveyors, portal cranes, warehouse cranes, loading cranes or similar. Such non-constant conveyors, known in the trade as process cranes, can be programmed with respect to their movement sequences and allow a precise approach to a specific position. Therefore, they allow high transport speeds which are higher than with known bag conveyor systems. Above all, the transport paths of the non-constant conveyors may be shorter than with known bag conveyor systems. In said non-constant conveyors, the at least one container or loading container and/or unloading container constitutes the respective load-receiving means for the laundry.

Alternatively, commercial programmable robots may be used as non-constant conveyors. These may be simple robots because in order to implement the invention, the conveyors, in particular constant conveyors, need only have load-receiving means (namely the at least one container, the loading container and/or unloading container) which can travel in two dimensions or along two axes in one plane, preferably a horizontal plane.

### BRIEF DESCRIPTION OF THE DRAWINGS

Preferred exemplary embodiments of the invention are explained below with reference to the drawing. This shows:

FIG. 1 is a first device which is suitable for performance of the method, in a schematic, perspective depiction;

FIG. 2 is a second device which is also suitable for performance of the method according to the invention, in a schematic perspective depiction; and

FIG. 3 is a device which is also suitable for performance of the method and is a combination of the devices in FIGS. 1 and 2, also in a schematic perspective depiction.

### DETAILED DESCRIPTION OF PREFERRED EMBODIMENTS

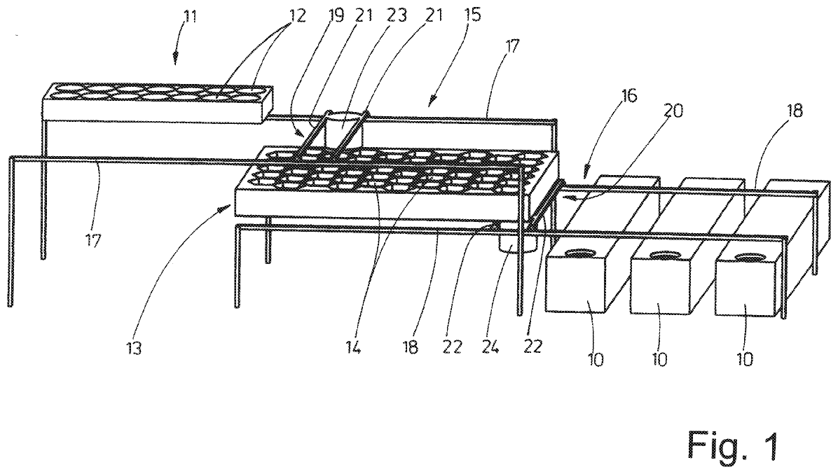

FIG. 1 shows the invention in connection with the supply of washing machines for commercial laundries, in this case continuous washing machines 10. Three continuous washing machines 10 arranged next to each other are assigned to the device. The invention is not however restricted to this. The number of continuous washing machines 10 may be greater or smaller. It is also conceivable to use the device in connection with other washing machines for commercial laundries, for example washer/spinner machines. It is also possible to use the device for dryers.

The device may be used for loading continuous washing machines 10, or other laundry machines for commercial laundries, with laundry to be washed (dirty washing) of all types, i.e. flat linen, shaped items, dry-cleaning, carpets, mats and similar textile objects.

The dirty washing delivered (not shown here) is preferably first sorted in a sorting station 11. Sorting takes place by type and/or color of laundry and special treatment criteria, in particular in the respective continuous washing machine 10. Laundry items which can be treated together with other laundry items in a common laundry batch or a same laundry load are deposited at a collection site 12 of the sorting station 11 provided for this. Usually, not only similar laundry items and laundry items of the same color are deposited in the same storage site 12, but also laundry items which are to be treated similarly, in particular washed.

The sorting station 11 has a plurality of collection sites 12 arranged next to and behind one another. The number of collection sites 12 of the sorting station 11 corresponds to the number of different washing criteria and/or washing programs of the respective continuous washing machine 10. In addition, other sorting criteria may be assigned to the collection sites 12, e.g. color of laundry, material of the fabric and/or the type of laundry.

A store 13 is arranged between the collection site 12 and the series of continuous washing machines 10 which are arranged parallel and next to each other. The store 13 has a plurality of storage sites 14 which are preferably formed identically. All storage sites 14 are arranged next to and behind one another in rows and columns in one horizontal plane. All storage sites 14 thus lie next to and behind one another in a preferably even grid pattern.

In the exemplary embodiment shown, all storage sites 14 have a hexagonal cross-section of the same size. Also, all storage sites 14 adjoin each other, so that the complete grid of all storage sites 14 forms a honeycomb-like store 13 when viewed from above. The storage sites 14 lying next to and behind one another adjoin each other, so that each of the six same-sized walls of an internal storage site 14 form a wall of another storage site 14 arranged adjacent to and in a ring around the first internal storage site 14 concerned.

Alternatively, it is conceivable to form the similar storage sites 14 with a square contour or cross-section of the same size. Here, each wall surface of an internal storage site 14 forms a wall surface of the four adjacent square storage sites 14. In this case, viewed from above, the store 13 has a checkerboard-like pattern.

Because of the hexagonal or square bottom faces or cross-sections of all storage sites 14 of the respective store 13, there are no spaces between adjacent storage sites 14. This creates a compact store 13, the bottom surface area of which is almost completely available for receiving laundry to be washed. Also, because adjacent hexagonal or also square storage sites 14 adjoin each other directly, all storage sites 14 are at the same time interconnected and/or connected together in order to form the store 13.

The store 13 shown has six rows of ten successive storage sites 14, i.e. a total of sixty storage sites 14. The invention is not however restricted to this. Depending on requirements and on the number and capacity of the adjacent continuous washing machines 10, the store 13 may have a greater or lesser number of identical storage sites 14.

Each storage site 14 is open at the top. At the bottom, each storage site 14 has a floor. The floor is formed as a flap or slider so that the underside of each storage site 14 can be opened in targeted fashion for unloading the laundry to be washed at the respective storage site 14.

A first non-constant conveyor 15 is provided between the sorting station 11 and the store 13. A second non-constant conveyor 16 is arranged between the store 13 and the group of continuous washing machines 10, which are arranged spaced apart from and next to each other. Both non-constant conveyors 15, 16 are arranged stationarily between the store 13 and the sorting station 11, or between the store 13 and continuous washing machines 10 respectively. The non-constant conveyors 15, 16 are formed similarly in the manner of cranes. For example, the first and second non-constant conveyors 15, 16 may both be formed as process cranes, in particular programmable and/or automatically controllable process cranes, but also as programmable and/or controllable warehouse cranes or loading cranes.

The two non-constant conveyors 15 and 16 each have a load receiver which can travel along two axes in one horizontal plane. The load receiver is accordingly able to travel to and fro between the store 13 and the sorting station 11, or between the store 13 and continuous washing machines 10 respectively, and can also move transversely above these. To this end, each non-constant conveyor 15 and 16 has two parallel longitudinal tracks 17, 18 which extend from the sorting station 11 to the store 13, and from the store 13 to the rearmost continuous washing machine 10. The sorting station 11 and the store 13 are arranged offset in height to each other so that the longitudinal tracks 17 of the first non-constant conveyor 15 lie in one horizontal plane, which runs spaced below the undersides of the collection sites 12 of the sorting station 11 and spaced above the top sides of the storage sites 14 of the store 13. The two parallel longitudinal tracks 18 of the second non-constant conveyor 16 lie in a lower horizontal plane, which extends spaced below the underside of the store 13 and spaced above the adjacent continuous washing machines 10 up to the rearmost continuous washing machine 10.

Each non-constant conveyor 15 and 16 has a bridge 19 and 20 which runs at right angles to the longitudinal tracks 17 and 18, and the opposite ends of which are mounted in or in particular on the longitudinal tracks 17, 18. In this way, the respective bridge 19 and 20 can move to and fro on the parallel longitudinal tracks 17 and 18, in the longitudinal direction thereof. Each bridge 19 and 20 carries the load-receiving means. In the figures of the drawings, each bridge 19 and 20 is depicted merely symbolically. This depiction shows two parallel transverse tracks 21 and 22 of each bridge 19, 20. The load-receiving means can travel in or on the two parallel transverse tracks 21 or 22 of each bridge 19, 20. In this way, the load-receiving means of each non-constant conveyor 15 and 16 can also travel transversely to the travel path of the respective bridge 19, 20, along the two parallel longitudinal tracks 17, 18 of the non-constant conveyor 15 or 16.

In the device shown here, the load-receiving means of the first non-constant conveyor 15 is formed as a container 23 for the laundry from a collection site 12 of the sorting station 11. Similarly, the load-receiving means of the second non-constant conveyor 16 is formed as a loading container 24. The container 23 and the loading container 24 are preferably configured as receptacles, in particular solid and/or rigid receptacles. At least the loading container 24 preferably has a capacity corresponding to the largest batch of washing with which the continuous washing machines 10 can be loaded. The container 23 may be slightly smaller if a washing batch in the respective storage site 14 can be formed by repeated emptying of a container 23 above preferably the same storage site 14.

In the exemplary embodiment shown, the container 23 and the loading container 24 are formed identically. Thus, the container 23 and the loading container 24 here have a cylindrical form with circular bottom face. The diameter of the container 23 and the loading container 24 is selected so as to correspond to the bottom faces of the storage sites 14 and also of the collection sites 12. In the case of a cylindrical container 23 and loading container 24, the diameter corresponds approximately to the corner dimension of the identical hexagonal storage sites 14. It is however also conceivable to provide both the container 23 and the loading container 24 with bottom faces or cross-sections which correspond to the preferably identical and/or same-sized cross-sections of the storage sites 14 and/or collection sites 12, i.e. also hexagonal in the case of the exemplary embodiment shown in FIG. 1.

The container 23 and the loading container 24 are completely open on their top side, wherein the bridges 19 and 20 are configured so as to leave the top sides of the container 23 and loading container 24 completely free. However, the undersides of the container 23 and loading container 24 have a floor. This floor is configured such that it can be opened for unloading the container 23 or loading container 24. To this end, the floor is formed either as a slider or as a flap, wherein the floor of the container 23 and loading container 24 is opened and closed preferably mechanically, for example by means of a pivot cylinder.

The method according to the invention is explained as an example below with reference to the device shown in FIG. 1.

The dirty washing delivered to the laundry is preferably firstly sorted. This may take place manually or also automatically. Sorting takes place in the sorting station 11, of which the collection sites 12 are shown merely diagrammatically in FIG. 1. Each collection site 12 is provided for laundry items which belong to the same laundry batch or load.

When for example a collection site 12 of the sorting station 11 is full or contains a specific number of laundry items which preferably corresponds to a laundry load and/or batch, the container 23 of the first non-constant conveyor 15 moves to below this collection site 12 with the floor closed. The underside, preferably the floor, of the collection site 12 concerned is then opened so that the laundry collected therein can fall into the container 23 under force of gravity.

The container 23 filled with laundry is now moved by the first non-constant conveyor 15 to above the store 13. This takes place such that the container 23 with laundry therein is moved to above any arbitrary empty storage site 14 of the store 13, preferably an empty storage site 14 which can be reached by the container 23 on the shortest path. It is however also conceivable to form a laundry batch in the respective storage site 14 by repeated emptying of the container 23, if the latter does not contain or cannot receive such a large quantity of laundry that is necessary to form a laundry batch (or load).

The laundry from the container 23 enters the storage site 14 of the store 13, again under force of gravity, wherein to transfer the laundry from the container 23 to the respective storage site 14, the floor of the container 23 is opened automatically, in particular mechanically, and closed again after emptying the container 23.

For loading a desired continuous washing machine 10, the second non-constant conveyor 16 moves the loading container 24 between the store 13 and the continuous washing machine 10. For this, firstly the loading container 24 of the second non-constant conveyor 16 is moved under targeted control to below the desired storage site 14 of the store 13, with the floor of the loading container 24 closed. Then the floor of the respective storage site 14 is opened so that the laundry from the storage site 14 falls into the loading container 24 under force of gravity. The laundry from the storage site 14 is thus transferred to the loading container 24. Now the second non-constant conveyor 16 moves the loading container 24 with laundry batch contained therein to above the continuous washing machine 10 which is to be loaded with the laundry batch concerned. When this has been done, the floor of the loading container 24 is opened automatically so that the laundry batch from the loading container 24 can fall into the respective continuous washing machine 10, in particular its loading chute, again under force of gravity. The loading of the continuous washing machine 10 is thereby completed.

Because the storage sites 14 of the store 13 are filled with laundry in disordered fashion, when the laundry is transferred from the container 23 into a storage site 14, preferably a position determination device of the first non-constant conveyor 15 determines above which storage site 14 the container 23 has been emptied, and this position, or also only a number assigned to the storage site 14 and allocated to the position of the respective storage site 14, is stored in a data memory. The stored positional data and/or the stored number are made available to the controller of the non-constant conveyors 15 and 16 so that the latter can use this. Preferably, in addition to the positional data from the conveyor 23 on unloading of the laundry into a storage site 14, information on the laundry discharged into the respective storage site 14 from the container 23 is also determined and stored. For example, this may be data on the type, color and/or fabric of the laundry.

A common controller for both non-constant conveyors 15 and 16, or separate controllers for each non-constant conveyor 15, 16 which can both access the stored data, is/are used for moving the loading container 24 in targeted fashion to below the storage site 14 from which the laundry, in particular the laundry batch, of the corresponding storage site 14 should be extracted next for loading of a specific continuous washing machine 10. For this, the loading container 24 (also provided with a position determination device) travels to the stored position or number corresponding to the desired and/or selected storage site 14 from which the loading container 24 should next extract laundry, in particular a complete laundry batch or load, for loading of a continuous washing machine 10.

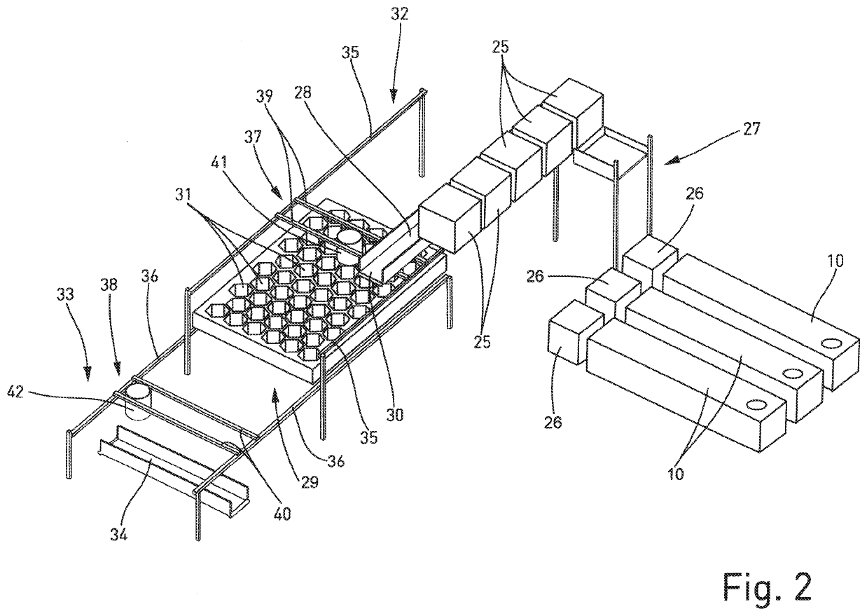

FIG. 2 illustrates a device for unloading treated laundry in batches or loads. The device shown unloads washed and dried laundry from a series of dryers 25.

The washed laundry leaving a respective continuous washing machine 10 is first drained in a drainage device 26 following each continuous washing machine 10, for example a drainage press or a spin-dryer, which removes at least the majority of the treatment liquid (bonded washing liquor) still contained in the laundry from the washing process. In FIG. 2, drainage devices 26 are shown behind each continuous washing machine 10. Fewer or only one drainage device 26 may however also be provided. In this case, drainage devices 26 may serve several continuous washing machines 10; in some cases, the single drainage device 26 serves all continuous washing machines 10 alternately.

In the exemplary embodiment of FIG. 2, the washed and drained laundry coming from the respective drainage device 26 is transported to a higher level by a laundry lift 27 or alternatively by a rising conveyor. This corresponds to the level on which, in the exemplary embodiment shown, a series of five successive and preferably identical dryers 25 are located. The number of dryers 25 may be greater than or less than five. As well as the series of successive dryers 25, on the unloading side of the dryer 25 is an elongate discharge conveyor 28. This may be a belt conveyor, a shaker or in the simplest case a sloping gully.

A store 29 is situated behind the discharge conveyor 28. The store 29 is arranged below a discharge end 30 of the discharge conveyor 28, preferably at a distance below this. The store 29 has a plurality of preferably identical storage sites 31. All storage sites 31 are arranged next to and behind one another in rows and columns in one horizontal plane. All storage sites 31 thus lie in a preferably even grid pattern next to and behind one another. All storage sites 31 of the store 29 are formed in the same way as the storage sites 14 of the store 13. Reference is made to the associated description. Accordingly, the storage sites 31 of the store 29 are also arranged in a honeycomb-like or checkerboard-like pattern next to and behind one another, and have hexagonal or square bottom faces or cross-sections. Thus, there are no spaces between adjacent storage sites 31 of the same size.

The invention is not restricted to the exemplary number of storage sites arranged next to and behind one another as shown in FIG. 2. It is also conceivable that the number of storage sites 31 of the store 29 differs from the number of storage sites 14 of the store 13. It may be larger or smaller.

Each storage site 31 is open at the top. At the bottom, each storage site 31 is provided with a floor. This floor can be opened as required. For this, the floor is formed as a flap or slider in order to be able to open the underside or floor of each storage site 31 in targeted fashion in order to unload the washed and dried laundry from the respective storage site 31.

A first non-constant conveyor 32 is provided between the series of dryers 25 and the discharge conveyor 28 assigned to the dryers 25 and the store 29. A second non-constant conveyor 33 is assigned to the store 29 such that it can transport away laundry extracted from the at least one storage site 31, for example to a discharge conveyor 34 (depicted schematically in FIG. 2) which supplies the washed and dried laundry for further processing, in particular to a mangle and/or folding machine. For this, the second non-constant conveyor 33 is preferably arranged below and behind the store 29. The first non-constant conveyor 32 serves to load the storage sites 31 of the store 29 from above, while the second non-constant conveyor 33 serves to be loaded from above with laundry from the respective storage site 31 of the store 29.

The non-constant conveyors 32, 33 are formed in the same way as the non-constant conveyors 15, 16 of the exemplary embodiment of FIG. 1, namely similarly crane-like.

The two non-constant conveyors 32, 33 each have a load receiver which can be moved along two axes in one horizontal plane. The load receiver can be moved to and fro between the discharge end 30 of the discharge conveyor 28 and the store 29, and can also be moved transversely. For this, each non-constant conveyor 32, 33 has two longitudinal tracks 35 and 36 arranged parallel to and spaced apart from each other. The longitudinal tracks 35 of the first, higher non-constant conveyor 32 extend from the discharge conveyor 28 in the region of the dryer 25 to the store 29. The longitudinal tracks 36 of the second, lower non-constant conveyor run from the store 29 to the discharge conveyor 34 arranged behind this. The series of several dryers 25 and the discharge conveyor 28 are arranged offset in height relative to the store 29, such that the longitudinal tracks 35 of the first non-constant conveyor 32 lie in one horizontal plane which runs spaced below the dryers 25 of the discharge conveyor 28 and spaced above the top sides of the storage sites 31 of the store 29. The two parallel longitudinal tracks 36 of the second non-constant conveyor 33 lie in a lower horizontal plane which extends spaced below the underside of the store 29 and above the discharge conveyor 34.

Each non-constant conveyor 32 and 33, like the non-constant conveyors 15 and 16, has a respective bridge 37 and 38. The respective bridge 37 can be moved to and fro on the parallel longitudinal tracks 35, 36, in the longitudinal direction thereof.

Each bridge 37, 38 carries the load-receiving means. The respective bridge 37, 38 (indicated merely schematically in FIG. 2) has two parallel transverse tracks 39 and 40. The load-receiving means can move in or on the parallel transverse tracks 39 or 40 of each bridge 37, 38, in the longitudinal direction of the respective bridge 37, 38. In this way, the load-receiving means of each non-constant conveyor 32, 33 can also travel transversely to the travel path of the respective bridge 37, 39 and transversely to the longitudinal tracks 35, 36.

The load-receiving means of the first non-constant conveyor 32 is configured as an unloading container 41 for the washed and dried laundry from the dryers 25. The load-receiving means of the second non-constant conveyor 33 is formed by a container 42. The unloading container 41 and the container 42 are preferably formed as receptacles. In particular, these are rigid receptacles. At least the unloading container 41 has a capacity which corresponds to the laundry batch which can be dried in a respective dryer 25. The container 42 preferably has the same capacity. It is conceivable that the unloading container 41 and the container 42 have different capacities, wherein suitably the capacity of the container 42 corresponds at least to the capacity of the respective storage site 31.

Preferably, the unloading container 41 and the container 42 are formed similarly, in particular have a same cross-section. Also, the unloading container 41 and the container 42 correspond, in particular with respect to shape and in some cases also size, to the container 23 and the loading container 24 of the non-constant conveyors 15 and 16 from FIG. 1. Reference is made to this.

The unloading container 41 and the container 42 are completely open on their top sides, wherein the non-constant conveyors 32, 33, in particular their bridges 37 and 38, are configured such that they leave the open top sides of the unloading container 41 and container 42 completely free. The undersides of the unloading container 41 and container 42 are provided with a floor. The floor is configured such that it can be opened in order to unload the unloading container 41 and the container 42. This may take place in precisely the same fashion as described above in connection with container 23 and the loading container 24 of the device shown in FIG. 1.

The device in FIG. 2 may also be used for laundry which has not been dried in dryers 25. Then the washed laundry coming from the drainage device is first separated in a shaker. Above all, blocks of laundry coming from the drainage press are broken up and/or separated. The unloading container 41 is then filled with the separated laundry. This may take place directly via the discharge end of the shaker or also via a conveyor downstream of the shaker.

The method according to the invention is now explained as an example with reference to the device shown in FIG. 2.

The laundry which has been washed in a respective continuous washing machine 10, drained, and dried in a dryer 25 is discharged from the respective dryer 25 in batches or loads. Preferably, the entire laundry batch of a respective dryer 25 then enters the discharge conveyor 28. Via the discharge end 30 of the discharge conveyor 28, the laundry batch is then preferably transferred completely to the unloading container 41 so that the unloading container 41 is filled with the laundry batch. The first non-constant conveyor 32 then moves the unloading container 41 to above an arbitrary or selected empty storage site 31 of the store 29. Preferably, the unloading container 41 is moved to above an empty storage site 31 which can be reached via the shortest path. It is however also conceivable to load a same storage site 32 by repeated successive emptying of several unloading containers 41. This is preferably considered if the unloading container 41 does not contain or cannot hold such a large quantity of laundry that is required to fill the respective storage site 31 or which the respective storage site 31 can contain.

The laundry from the unloading container 41 then enters the respective storage site 31 of the store 29 under force of gravity, wherein to transfer the laundry from the unloading container 41 into the respective storage site 31, the floor of the unloading container 41 is opened automatically, in particular mechanically, and closed again after emptying of the unloading container 41.

The second non-constant conveyor 33 then moves the container 42, for loading thereof, between the store 29 and the downstream discharge conveyor 34. For this, firstly the container 42 is moved in targeted controlled fashion by the second discharge conveyor 33 to below the desired storage site 31 to be emptied of the store 29, with the floor of the container 42 closed. Then the floor of the respective storage site 31 is opened so that the laundry falls into the container 42 from the storage site 31 under force of gravity. The laundry is thus transferred from the storage site 31 to the container 42. Now the second non-constant conveyor 33 moves the container 42 with the laundry, in particular the washed and dried laundry batch, over the discharge conveyor 34 and the container 42 is emptied above the discharge conveyor 34. For this, the floor of the container 42 is opened automatically so that the laundry can fall into or onto the discharge conveyor 34 from the container 42, again under force of gravity. The process of unloading the dryer 25 is thus completed.

Again, in the device in FIG. 2, the storage sites 31 of the store 29 may be loaded with washed and dried laundry in disordered fashion. Then, preferably, a position determination device of the first non-constant conveyor 32 determines above which storage site 31 the unloading container 41 has emptied the laundry. This position is stored in a data memory. The stored positional data, or alternatively a previously established stored number of the unloading container 41, are made available to the controller of the non-constant conveyor 32 and/or 33 so that the latter can use this. It is also conceivable that on unloading the laundry into a preferably arbitrary storage site 31, information on the laundry which has been discharged into the respective storage site 31 by the unloading container 41 is determined and stored.

A common controller for both non-constant conveyors 32 and 33, or alternatively separate controllers for each non-constant conveyor 32 and 33 which can both access the stored data, namely positional data and/or number of the respective storage site 31, is/are used to move the container 42 in targeted fashion to below the storage site 31 from which laundry, in particular a laundry batch, should next be extracted from the storage site 31 and delivered to the discharge conveyor 34. The latter then moves the container 42, also provided with a position determination device, to the stored position which corresponds to the desired and/or selected storage site 31. After receiving the laundry from the reached storage site 31, the second non-constant conveyor 33 moves the container 42 to above the discharge conveyor 34. The container 42 is then opened by opening the floor, whereby the laundry of the laundry batch situated in the container 42 falls automatically and completely out of the container 42 onto the discharge conveyor 34.

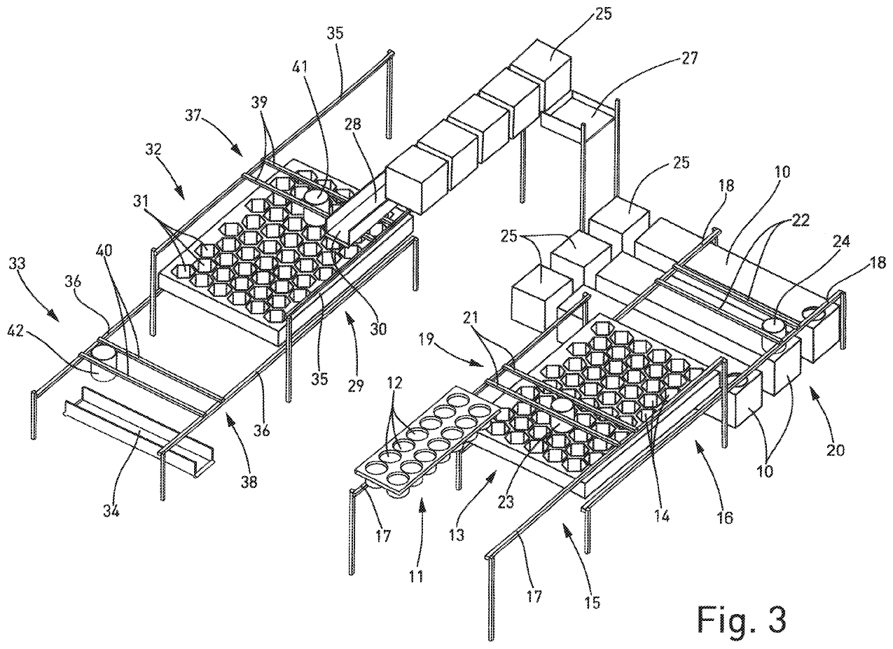

FIG. 3 shows a device according to a third exemplary embodiment of the invention. This device constitutes a combination of the devices from FIGS. 1 and 2 described above.

According to this exemplary embodiment, a store 13 and two non-constant conveyors 15 and 16 assigned thereto are arranged in front of the continuous washing machines 10. Behind the continuous washing machines 10, and namely behind the dryers 25 following the continuous washing machines 10 and with discharge conveyor 28 assigned thereto, a further store 29 is provided, to which a further two non-constant conveyors 32 and 33 are assigned.

In the device according to FIG. 3, untreated laundry (in particular dirty washing) may be temporarily stored in the store 13 in front of the continuous washing machines 10. Similarly, untreated laundry (in the exemplary embodiment shown, washed, drained and dried laundry) may be temporarily stored in the second store 29 behind the dryers 25. Since two non-constant conveyors 15 and 16 firstly, and two non-constant conveyors 32 and 33 secondly, are assigned to each store 13 and 29 respectively, each store 13 and 29 can be served compactly and individually by the non-constant conveyors 15, 16 or 32, 33 respectively.

The store 13 is loaded by the respective container 23 of the non-constant conveyor 15. The store 13, namely its respective storage site 14, is unloaded by the loading container 24 of the non-constant conveyor 16, and the desired continuous washing machine 10 is loaded with the laundry in the loading container 24.

The dried laundry is taken from the respective dryer 25 by a respective unloading container 41 and transferred to the desired storage site 31 of the store 29. A batch of treated laundry can then be extracted by the container 42 from the store 29, namely from the respective desired storage site 31 thereof. The laundry is then transported by the non-constant conveyor 33 from the container 42, for example to the discharge conveyor 34 shown in FIG. 3, and transferred from the container 42 to the latter.

### LIST OF REFERENCE SIGNS

10 Continuous washing machine
11 Sorting station
12 Collection site
13 Store
14 Storage site
15 Non-constant conveyor (first)
16 Non-constant conveyor (second)
17 Longitudinal track
18 Longitudinal track
19 Bridge
20 Bridge
21 Transverse track
22 Transverse track
23 Container
24 Loading container
25 Dryer
26 Drainage device
27 Laundry lift
28 Discharge conveyor
29 Store
30 Discharge end
31 Storage site
32 Non-constant conveyor
33 Non-constant conveyor
34 Discharge conveyor
35 Longitudinal track
36 Longitudinal track
37 Bridge
38 Bridge
39 Transverse track
40 Transverse track
41 Unloading container
42 Container

What is claimed is:

1. A method for loading and/or unloading laundry machines with laundry, wherein the laundry is transported to the laundry machine to be loaded, and the laundry is loaded into the laundry machine and/or unloaded from the laundry machine and transported away, wherein the laundry is transported to at least one store (13, 29) and temporarily stored there, wherein the laundry is transported from the store (13) to the laundry machine and the laundry machine is loaded with the laundry, and/or wherein the laundry unloaded from a laundry machine is transported to another store (29) and temporarily stored there.

2. The method as claimed in claim 1, wherein the laundry to be treated is transported in a container (23) to the store (13) for laundry to be treated, the laundry is transferred from the container (23) to the store (13), the laundry is extracted from the store (13) by a loading container (24), the laundry in the loading container (24) is transported by said container to the respective laundry machine, and by unloading the loading container (24) the laundry machine is loaded with the laundry, and/or the treated laundry unloaded from the laundry machine is loaded into an unloading container (41), transported thereby to a store (29) for treated laundry, and discharged from the unloading container (41) to the store (29).

3. The method as claimed in claim 2, wherein the respective laundry machine is loaded with a laundry batch formed by laundry from at least one of the container (23).

4. The method as claimed in claim 2, wherein a batch of laundry unloaded from the laundry machine is loaded into the unloading container (41).

5. The method as claimed in claim 2, wherein the laundry is transferred from the container (23) into a loading container (24) in the region of the store (13) for laundry to be treated.

6. The method as claimed in claim 2, wherein the treated laundry is transferred from the unloading container (41) into a container (42) in the region of the store (29) for treated laundry.

7. The method as claimed in claim 2, wherein the container (23) loaded with laundry is transported to the store (13) for untreated laundry by a first non-constant conveyor (15), and the loading container (24) loaded with treated laundry is transported from the store (23) to the laundry machine by a second non-constant conveyor (16).

8. The method as claimed in claim 2, wherein the unloading container (41) loaded with treated laundry is transported to the store (29) for treated laundry by a first non-constant conveyor (32), and a container (42) loaded with laundry is transported away from the store (29) by a second non-constant conveyor (33).

9. The method as claimed in claim 2, wherein the laundry from the container (23) is discharged into any free storage site (14) of the respective store (13) having a plurality of the storage sites (14) for laundry from the container (23).

10. The method as claimed in claim 2, wherein the laundry from the unloading container (41) is discharged into any free storage site (31) of the store (29) having a plurality of the storage sites (31) for laundry from the unloading container (41).

11. The method as claimed in claim 2, wherein the positions at which the containers (23) transfer laundry to the respective storage site (14; 31) are determined and stored as data, a controller of at least one non-constant conveyor (16; 33) receives these data and on the basis of said data, the controller of at least one non-constant conveyor (16; 33) moves its respective loading container (24) in targeted fashion to the storage site (14; 31) of the respective store (13; 29) from which laundry will later be extracted by the loading container (24) for loading the laundry machine.

12. The method as claimed in claim 2, wherein the positions at which the unloading containers (41) transfer laundry to a storage site (14; 31) are determined and stored as data, a controller of at least one non-constant conveyor (16; 33) receives these data and on the basis thereof, the controller of at least one non-constant conveyor (16; 33) moves its respective container (42) in targeted fashion to the storage site (14; 31) of the respective store (13; 29) from which later laundry will be extracted by the container (42).

13. A device for loading and unloading laundry machines, with at least one conveyor for loading the laundry machine and/or for unloading the laundry machine, wherein at least one store (13; 29) with a plurality of storage sites (14; 31) is arranged in front of and/or behind the laundry machine to be loaded, wherein the laundry with a container (23) and/or unloading container (41) containing this can be moved by at least one first non-constant conveyor (15; 33) to the respective store (13; 29), and at least one second non-constant conveyor (16; 33) is provided with a loading container (24) and/or a container (42) which moves the laundry from a storage site (14; 31) of the respective store (13; 29) to the laundry machine to be loaded with the laundry, and/or transports treated laundry away.

14. The device as claimed in claim 13, wherein the at least one store (13; 29) has a plurality of coherent storage sites (14; 31) arranged in a grid pattern.

15. The device as claimed in claim 14, wherein the coherent and interconnected storage sites (14; 31) are arranged next to each other and successively in rows and columns in order to form the at least one store (13; 29).

16. The device as claimed in claim 13, wherein all the storage sites (14; 31) have an identical square or hexagonal bottom face, and the bottom faces of the or each container (23; 42), the loading container (24) and the unloading container (41) correspond to the bottom faces of each of the identically formed storage sites (14; 31).

17. The device as claimed in claim 13, wherein each storage site (14; 31) of the at least one store (13; 29), the at least one container (23; 42), the loading container (22) and the unloading container (41), have a floor which can be opened if required.

18. The device as claimed in claim 13, wherein the non-constant conveyors (15, 16; 32, 33) have position determination means for determining the position of the respective reached storage site (14; 31) into which laundry has been unloaded, wherein the respective positional data can be stored, and at least one controller is provided by which the respective loading container (24) can be moved to the position of a storage site (14; 31) of the respective store (13; 29) from which laundry should next be extracted by the loading container (24) for loading the laundry machine.

19. The device as claimed in claim 13, wherein the non-constant conveyors (15, 16; 32, 33) are formed identically, wherein the at least one container (23; 42) and the loading container (24) or unloading container (41) form load-receiving means of the non-constant conveyors (15, 16; 32, 33).

20. The device as claimed in claim 13, wherein the non-constant conveyors (15, 16; 32, 33) are formed similarly in the manner of cranes, grippers or robots.

21. The device as claimed in claim 13, wherein the non-constant conveyors (15, 16; 32, 33) are configured as rapidly moving programmable process cranes, portal cranes, warehouse cranes or loading cranes.

22. The device as claimed in claim 13, wherein the at least one container (23; 42) can be moved by the respective non-constant conveyor (15, 16; 32, 33) along at least two axes in one plane.

23. The device as claimed in claim 13, wherein the at least one loading container (24) and the at least one unloading container (41) can be moved by the respective non-constant conveyor (15, 16; 32, 33) along at least two axes in one horizontal plane.
